(19) United States
(12) Patent Application Publication
(10) Pub. No.: US 2014/0010315 A1
(43) Pub. Date: Jan. 9, 2014

(54) METHOD AND SYSTEM FOR DYNAMIC CABLE MODEM TERMINATION SYSTEM (CMTS) PORT TO DEMODULATOR ASSIGNMENT IN A CABLE HEADEND (HE)

(71) Applicants: Curtis Ling, Carlsbad, CA (US); Tim Gallagher, Encinitas, CA (US); Sridhar Ramesh, Carlsbad, CA (US)

(72) Inventors: Curtis Ling, Carlsbad, CA (US); Tim Gallagher, Encinitas, CA (US); Sridhar Ramesh, Carlsbad, CA (US)

(21) Appl. No.: 13/937,088

(22) Filed: Jul. 8, 2013

Related U.S. Application Data
(60) Provisional application No. 61/668,825, filed on Jul. 6, 2012.

(51) Int. Cl. H04B 3/00

(52) U.S. Cl. CPC H04B 3/00
USPC 375/257

(57) ABSTRACT

A cable modem device may include a plurality of cable modem termination system demodulators, a switching element and a plurality of cable termination system modem ports. The cable modem may receive signals from one of a plurality of downstream cable modems at one of the plurality of cable modem termination system ports and dynamically assign one of the plurality of cable modem termination system demodulators to one of the plurality of cable modem termination system ports. The signals received from the one of the plurality of downstream cable modems may be demodulated by the assigned one of the plurality of cable modem termination system demodulators. The assigned one of the plurality of cable modem termination system demodulators may be communicatively coupled to one of the plurality of cable modem termination system ports by the switching element. The switching element is operable to dynamically couple any one of the plurality of cable modem termination system demodulators to anyone of the plurality of cable modem termination system ports.

### CROSS-REFERENCE TO RELATED APPLICATIONS/INCORPORATION BY REFERENCE

This patent application makes reference to, claims priority to and claims benefit from the U.S. Provisional Patent Application Ser. No. 61/668,825, filed on Jul. 6, 2012.

This patent application also makes reference to: U.S. patent application Ser. No. 13/730,352, filed on Dec. 28, 2012;

Each of the above stated applications is hereby incorporated herein by reference in its entirety.

### FIELD OF THE INVENTION

Certain embodiments of the invention relate to communication of data. More specifically, certain embodiments of the invention relate to a method and system for dynamic cable modem termination system port to demodulator assignment in a cable headend.

### BACKGROUND OF THE INVENTION

Cable service providers typically utilize coaxial medium or variants thereof such as hybrid fiber coaxial (HFC) medium to transport multimedia information from their cable headend (HE) to customer premise equipment (CPE), which are utilized to provide cable-based services within a home or office. The CPE may comprise, for example, set top boxes (STB), cable modems, integrated cable modems and routers and cable converter boxes. The cable modems, and the integrated cable modem and routers comprise an Ethernet or other high-speed interface such as USB or FireWire and a second RF interface. The RF interface is utilized to transport the cable modem traffic over the cable or HFC medium to the cable HE.

Existing cable plants struggle to support demands for higher upstream bandwidth and higher downstream bandwidth.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for dynamic cable modem termination system port to demodulator assignment in a cable headend, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram that illustrates an exemplary cable system that utilizes a plurality of burst receivers and port switching in a cable headend, in accordance with an exemplary embodiment of the invention.

FIG. 2 is a block diagram that illustrates an exemplary cable modem termination system that utilizes a plurality of burst receivers and port switching in the cable headend, in accordance with an exemplary embodiment of the invention.

FIG. 3 is a block diagram that illustrates exemplary port switching for a plurality of burst receivers in a cable modem termination system in the cable headend, in accordance with an exemplary embodiment of the invention.

FIG. 4 is a flow chart illustrating exemplary steps for port switching for a plurality of burst receivers in a cable modem termination system in the cable headend, in accordance with an exemplary embodiment of the invention.

### DETAILED DESCRIPTION OF THE INVENTION

Certain embodiments of the invention may be found in a method and system for dynamic cable modem port to demodulator assignment in a cable headend. In various embodiments of the invention, a cable modem termination system device may include a plurality of cable modem termination system burst demodulators, a switching element and a plurality of cable modem termination system ports. The cable modem termination system device may receive signals from one or more of a plurality of downstream cable modems at one of the plurality of cable modem termination system ports and dynamically assign one of the plurality of cable modem termination system demodulators to one of the plurality of cable modem termination system ports. The signals received from the one of the plurality of downstream cable modems may be demodulated by the assigned one of the plurality of cable modem termination system demodulators. The assigned one of the plurality of cable modem termination system demodulators may be communicatively coupled to one of the plurality of cable modem termination system ports by the switching element. The switching element is operable to dynamically couple any one of the plurality of cable modem termination system demodulators to any one of the plurality of cable modem termination system ports.

The plurality of cable modem termination system demodulators may be maintained as a pool of demodulating resources. Each of the plurality of cable modem termination system demodulators in the pool of demodulating resources may be assigned a status. In this regard, a status of one or more of the plurality of cable modem termination system demodulators within the pool of demodulating resources may be marked as being available when the one or more cable modem termination system demodulators is available to handle demodulation of signals received at the one or more of the plurality of cable modem termination system ports. The status of the one or more of the plurality of cable modem termination system demodulators within the pool of demodulating resources may be marked as being unavailable when the one or more cable modem termination system demodulators is unavailable to handle demodulation of signals received at the one or more of the plurality of cable modem termination system ports. The status of the one of the plurality of cable modem termination system demodulators may be determined prior to the assigning. The one of the plurality of cable modem termination system demodulators may be assigned to the one of the plurality of cable modem termination system ports when the determined status of the one of the plurality of cable modem termination system demodulators is available. Another of the plurality of cable modem termination system demodulators may be assigned to the one of the plurality of cable modem termination system ports whenever the determined status of the one of the plurality of cable modem termination system ports is unavailable. Two or more of the plurality of cable modem termination system demodulators may be dynamically assigned to handle signals received from two or more of the plurality of cable modem termination system ports based on a class of service, latency and/or quality of service associated with the received signals. The switching element may comprise a crossbar switch, for example.

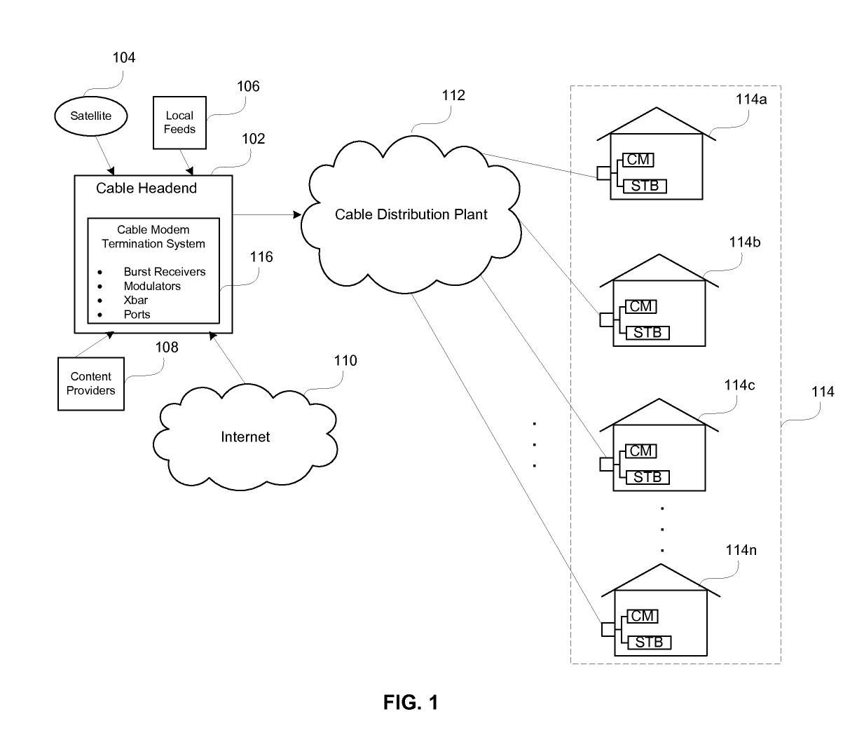

FIG. 1 is a block diagram that illustrates an exemplary cable system that utilizes a plurality of burst receivers and port switching in a cable headend, in accordance with an exemplary embodiment of the invention. Referring to FIG. 1, there is shown a cable headend 102, a cable distribution plant 112 and residences and businesses 114.

The cable headend comprises a cable modem termination system 116, the latter of which comprises a plurality of burst receivers, modulators, a switching element (e.g., a crossbar (XBAR)), and a plurality of ports. The cable headend 102 is shown coupled to a plurality of other systems comprising a satellite system 104, local information feeds 106, the Internet 110, and content providers 108. The cable headend 102 is also shown coupled to a cable distribution plant 112. The satellite system 104, the local information feeds 106, the Internet 110, and the content providers 108 provide content to cable headend 102.

The cable distribution plant 112 comprises suitable devices and media that are operable to transport cable network traffic. Exemplary media may comprise wired, wireless and/or optical media. The cable distribution plant 112 may be operable to transport and/or distribute content from the cable headend 102 to the home and offices 114. The cable distribution plant 112 is operable to transport information and content from the residences and/or businesses 114 to the cable headend 102.

The residences and/or businesses 114a, 114b, 114c, . . . , 114n are shown coupled to the cable distribution plant 112. The residences and/or businesses 114a, 114b, 114c, . . . , 114n may be collectively referenced as 114. Each of the residences and/or businesses 114a, 114b, 114c, . . . , 114n may comprise a cable modem and/or set top box that is operable to communicate with and receive media from the cable headend 102. Information may also be communicated from the residences and/or businesses 114a, 114b, 114c, . . . , 114n.

In accordance with various exemplary embodiments of the invention, in operation, the cable modem termination system 116 is operable to receive information and/or content from each of the residences and/or businesses 114a, 114b, 114c, . . . , 114n via the burst receivers. In this regard, any one of the burst receivers may be coupled, via the crossbar or switching element, to any of the cable modem termination system ports that handles the residences and/or businesses 114a, 114b, 114c, . . . , 114n.

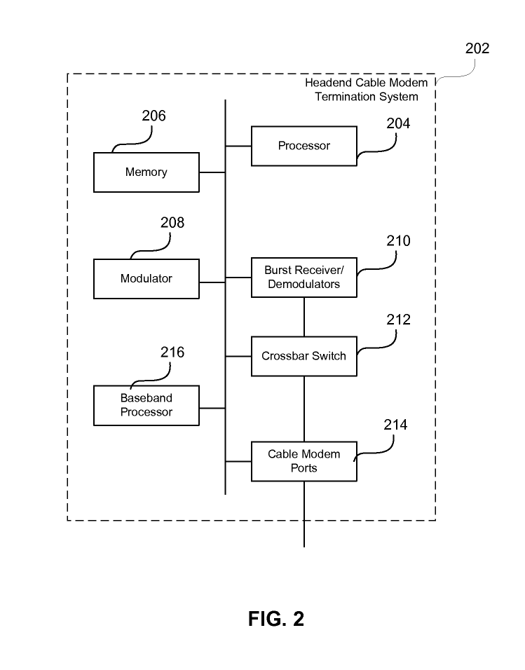

FIG. 2 is a block diagram that illustrates an exemplary cable modem termination system that utilizes a plurality of burst receivers and port switching in the cable headend, in accordance with an exemplary embodiment of the invention. Referring to FIG. 2, there is shown a cable modem termination system 202 in a headend. The cable modem termination system 202 may comprise a processor 204, a memory 206, a plurality of modulators 208, a plurality of burst receivers/demodulators 210, a crossbar switch 212, cable modem termination system ports 214 and a baseband processor 216. Although the processor 204 is shown separate from the baseband processor 216, the invention is not limited in this regard. Accordingly, the functions of the processor 204 and the baseband processor 216 may be combined or integrated and handled by a single processor.

The processor 204 may comprise suitable logic, circuitry and/or interfaces that may be operable to control the communication of signals from the cable headend to the customer premises, which are located downstream. The processor 204 may be operable to configure the cable modem termination system ports 214, the crossbar switch 212, the burst receiver/demodulators 210, the memory 206, the baseband processor 216 and/or the modulators 208.

The memory 206 may comprise suitable logic, circuitry interfaces and/or code that may be operable to store information that may be transmitted by and/or received by the cable headend. The memory 206 may be operable to store information that may be utilized to configure one or more of the cable modem termination system 202, the processor 204, the plurality of modulators 208, the plurality of burst receivers/demodulators 210, the crossbar switch 212, the cable modem termination system ports 214, and/or the baseband processor 216.

Each of the plurality of modulators 208 may comprise suitable logic, circuitry and/or interfaces that may be operable to convert digital signals to RF signals. The resulting RF signals may be communicated from the cable headend 102 to a corresponding one of the cable modems and/or set top boxes located in the residences and/or businesses 114a, 114b, 114c, . . . , 114n.

Each of the plurality of burst receivers/demodulators 210 may comprise suitable logic, circuitry and/or interfaces that may be operable to convert received RF signals that may be communicated from any of the cable modems and/or set top boxes located in the residences and/or businesses 114a, 114b, 114c, . . . , 114n, to digital signals. The burst receivers/demodulators may be also be referred to as cable modem termination system demodulators.

The crossbar switch 212 may comprise suitable logic, circuitry and/or interfaces that may be operable to couple any of the cable modems and/or set top boxes located in the residences and/or businesses 114a, 114b, 114c, . . . , 114n to any of the burst receivers or demodulators located in the cable modem termination system 116. In this regard, the cross-bar may comprise a plurality of switches that may be activated or deactivated to select a desired receive (Rx) path or Rx port that couples one of the plurality of residences and/or businesses 114a, 114b, 114c, . . . , 114n. A processor, such as the processor 204, the baseband processor 216, and/or the burst receivers or demodulators 210 may be operable to configure the switches in the crossbar switch 212.

Each of the cable modem termination system ports 214 may comprise suitable logic, circuitry and/or interfaces that may be coupled to and operable to receive information and/or content from any of the cable modems that are located at the customer premises or the residences and/or businesses 114a, 114b, 114c, . . . , 114n. In accordance with various embodiments of the invention, each of the cable modem termination system ports 214 may be operable to handle a plurality of cable modems located in the customer premises or the residences and/or businesses 114a, 114b, 114c, . . . , 114n.

The baseband processor 216 may be operable to process baseband signals resulting from demodulation by the plurality of burst receivers/demodulators 210. The baseband signals resulting from demodulation by the plurality of burst receivers/demodulators 210 may be stored in the memory 206. The baseband processor 216 and/or the processor 204 may be operable to configure the crossbar switch 212 to couple any one of the cable modem termination system ports 214 to any channel corresponding to one of the plurality of the burst receivers/demodulators, which is selected to handle processing of signals received from any one of the customer premises cable modems. The customer premises cable modems are located in the residences and/or businesses 114a, 114b, 114c, . . . , 114n. In this manner, any one of the cable modem termination system ports 214 is operable to handle traffic from any channel for one of the residences and/or businesses 114a, 114b, 114c, . . . , 114n.

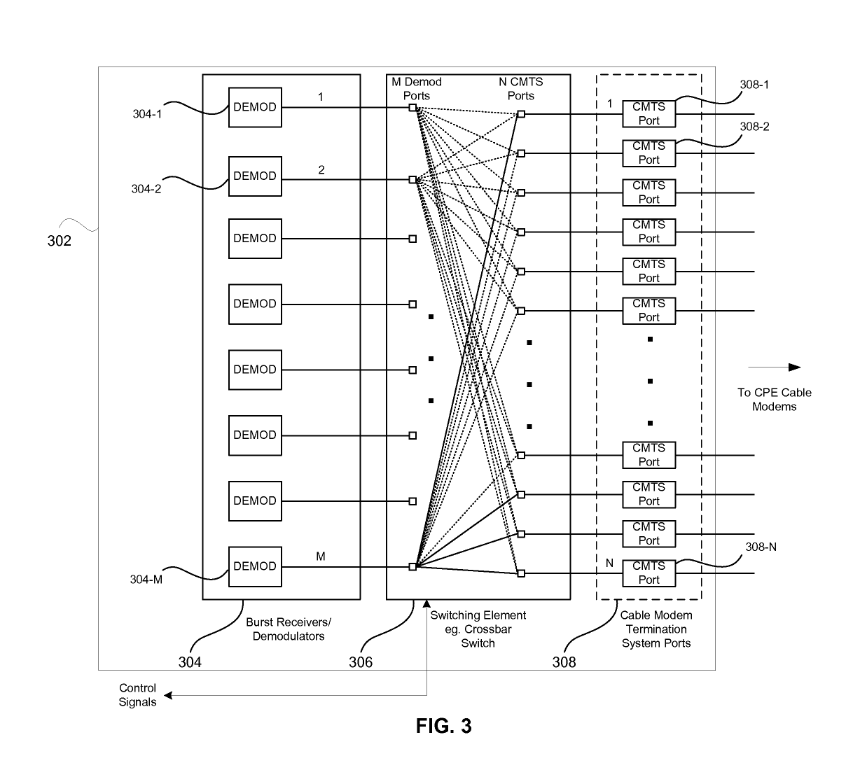

FIG. 3 is a block diagram that illustrates exemplary port switching for a plurality of burst receivers in a cable modem termination system in the cable headend, in accordance with an exemplary embodiment of the invention. Referring to FIG. 3, there is shown a cable modem termination system 302 comprising a burst receiver or demodulator module 304, a switching element such as a cross bar switch 306 and a cable modem termination system port module 308.

The burst receiver or demodulator module 304 may comprise a plurality of burst receivers/demodulators. In one embodiment of the invention, the burst receiver or demodulator module 304 may comprise a single chip having a plurality of burst receivers or demodulators integrated therein. In order to increase the number of burst receivers/demodulators with the cable modem termination system 116, a plurality of chips, each of which may comprise one or more burst receivers/demodulators, may be coupled together. In some embodiments of the invention, the plurality of chips may be integrated in one or more packages. Each of the plurality of burst receivers/demodulators 210 may comprise suitable logic, circuitry and/or interfaces that may be operable to convert received RF signals that may be communicated via a corresponding channel from any of the cable modems and/or set top boxes located in the residences and/or businesses 114a, 114b, 114c, . . . , 114n, to digital signals. The resulting digital signals may be processed by the baseband processor 216 and/or the processor 204.

In one embodiment of the invention, each of the burst receivers/demodulators amongst the plurality of burst receivers/demodulators 304-1, 304-2, . . . , 304-M may be assigned (e.g., randomly, sequentially, and/or in accordance with some other algorithm for efficient use of the plurality of burst receivers/demodulators 304-1, 304-2, . . . , 304-M) to demodulate data from any of the cable modem termination system ports 308-1, 308-2, . . . , 308-N. Which of the burst receivers/demodulators 304-1, 304-2, . . . , 304-M is assigned to which of the cable modem termination system ports 308-1, 308-2, . . . , 308-N may depend, for example, on how many cable modems are active and/or attached to each of the cable modem termination system ports 308-1, 308-2, . . . , 308-N. The assignment of any of the burst receivers/demodulators 304-1, 304-2, . . . , 304-M to demodulate data from any of the cable modem termination system ports 308-1, 308-2, . . . , 308-N may occur dynamically and/or adaptively.

In accordance with some embodiments of the invention, two or more of the plurality of burst receivers/demodulators 304-1, 304-2, . . . , 304-M may be dynamically assigned to handle signals received from two or more of the plurality of cable modem termination system ports 308-1, 308-2, . . . , 308-N based on, for example, a class of service, latency and/or quality of service associated with the received signals.

The plurality of burst receivers/demodulators 304-1, 304-2, . . . , 304-M may be maintained as a pool of demodulating resources in order to efficiently manage the assignments of the plurality of burst receivers/demodulators 304-1, 304-2, . . . , 304-M. In this regard, each of the plurality of burst receivers/demodulators 304-1, 304-2, . . . , 304-M in the pool of demodulating resources may be assigned a status. In an exemplary embodiment of the invention, a status of one or more of the plurality of burst receivers/demodulators 304-1, 304-2, . . . , 304-M within the pool of demodulating resources may be designated or marked as being available in instances when the one or more burst receivers/demodulators 304-1, 304-2, . . . , 304-M is available to handle demodulation of signals received at the one or more of the plurality of cable modem termination system ports 308-1, 308-2, . . . , 308-N. The status of the one or more of the plurality of burst receivers/demodulators 304-1, 304-2, . . . , 304-M within the pool of demodulating resources may be designated or marked as being unavailable in instances when the one or more burst receivers/demodulators 304-1, 304-2, . . . , 304-M 304-1, 304-2, . . . , 304-M is unavailable to handle demodulation of signals received at the one or more of the plurality of cable modem termination system ports. An available burst receiver/demodulator may be allocated from the pool of demodulating resources to handle demodulation of the signals received at the one or more of the plurality of cable modem termination system ports 308-1, 308-2, . . . , 308-N. Once an available burst receiver/demodulator is allocated from the pool of demodulating resources, its status is marked as being unavailable. Upon completion of demodulation of the signals received at the one or more of the plurality of cable modem termination system ports 308-1, 308-2, . . . , 308-N, the burst receiver/demodulator is deallocated and returned to the pool of demodulating resources. Once the deallocated burst receiver/demodulator is returned to the pool of demodulating resources, its status may be marked as being available.

In general, prior to assignment of a cable modem termination system demodulator to handle demodulation for a particular cable modem termination system port, a status of the cable modem termination system demodulator may be determined. A particular one of the plurality of burst receivers/demodulators 304-1, 304-2, . . . , 304-M may be assigned to the one of the plurality of cable modem termination system ports 308-1, 308-2, . . . , 308-N if the determined status of that particular one of the plurality of burst receivers/demodulators 304-1, 304-2, . . . , 304-M is marked as being available. If the particular one of the plurality of cable modem termination system demodulators 304-1, 304-2, . . . , 304-M is marked as being unavailable, another one of the plurality of burst receivers/demodulators 304-1, 304-2, . . . , 304-M may be assigned to the one of the plurality of cable modem termination system ports 308-1, 308-2, . . . , 308-N.

In accordance with various embodiments of the invention, ranging information for the burst receivers/demodulators 304-1, 304-2, . . . , 304-m may be stored in memory such as the memory 206. Accordingly, in instances when a particular burst receiver/demodulator is turned on, stored ranging information may be acquired from the memory 206 and utilized to initialize that burst receiver/demodulator. This significantly reduces the startup time of the burst receiver/demodulator since it may not be necessary to determine the ranging information once it gets assigned and/or ranging information may be determined using a modified ranging process that requires less time to complete than a conventional ranging process by utilizing the stored ranging information. Once a burst receiver/demodulator is assigned and becomes active, it may be operable to determine and store updated ranging information before it is turned off or de-assigned. Channel information (e.g., SNR, modulation type, etc.) may also be stored in the memory 206 and whenever a burst receiver/demodulator is assigned and is powered on, such burst receiver may acquire stored channel information in order to optimize demodulation of a particular channel.

The crossbar switch 306 may comprise suitable logic, circuitry and/or interfaces that may be operable to couple any of the cable modem termination system ports (CMTS ports) 308-1, 308-2, . . . , 308-n to any of the burst receivers/demodulators 304-1, 304-2, . . . , 304-m. The cable modem termination system ports 308-1, 308-2, . . . , 308-n may each handle a plurality of cable modems and/or set top boxes located in the residences and/or businesses 114a, 114b, 114c, . . . , 114n. In this regard, any of the burst receivers or demodulators located in the cable modem termination system 116 may be utilized to demodulate data received via any of the cable modem termination system ports 308-1, 308-2, . . . , 308-n. In this regard, any of the burst receivers/demodulators 304-1, 304-2, . . . , 304-m may be assigned to handle a corresponding upstream signal from any cable modem in the residences and/or businesses 114a, 114b, 114c, . . . , 114n. A processor, such as the processor 204 and/or the burst receivers/demodulators 210 may be operable to configure the switches in the crossbar switch 212.

In an exemplary embodiment of the invention, the switches in the crossbar switch 306 may comprise CMOS transistors that may be activated by applying an appropriate gate voltage. The processor 204 and/or the baseband processor 216 may be operable to control the switches in the crossbar switch 306. In another embodiment of the invention, the switches in the crossbar switch 306 may comprise MEMS switches. In one embodiment of the invention, the MEMs switches may be integrated on a chip, which comprises the burst receivers/demodulators 304-1, 304-2, . . . , 304-m. In another embodiment of the invention, the MEMs switches may be integrated on a chip that is separate or different from the chip comprising the burst receivers/demodulators 304-1, 304-2, . . . , 304-m.

The cable modem termination system port module 308 comprises a plurality of ports, namely cable modem termination system ports 308-1, 308-2, . . . , 308-n. The cable modem termination system port module 302 may comprises suitable logic, circuitry and/or interfaces that is enabled to handle any upstream channels that are associated with the customer premise cable modems to the cable modem termination system system 202 in the headend.

The number of cable modems that may be handled by each of the cable modem termination system ports 308-1, 308-2, . . . , 308-n may vary depending on, for example, cable modem population density, channel usage, traffic type, bandwidth allocation, channel conditions such as SNR, SINR, CNR, and CINR, etc.

In an exemplary scenario, the crossbar switch 306 may be configured to couple the burst receiver/demodulator 304-1 to the cable modem termination system port 308-1 to receive RF signals from a cable modems associated with the residence or business 114a and to couple the burst receiver/demodulator 304-2 to the cable modem termination system port 308-n to receive RF signals from a cable modem associated with the residence or business 114n. In another exemplary scenario, the crossbar switch 306 may be configured to couple the burst receiver/demodulator 304-2 to the cable modem termination system port 308-1 to receive RF signals from a cable modem associated with the residence or business 114a and to couple the burst receiver/demodulator 304-1 to the cable modem termination system port 308-n to receive RF signals from a cable modem associated with the residence or business 114n. In another exemplary scenario, the crossbar switch 306 may be configured to couple the burst receiver/demodulator 304-2 to the cable modem termination system port 308-1 to receive RF signals from a cable modem associated with the residence or business 114c and to couple the burst receiver/demodulator 304-1 to the cable modem termination system port 308-n to receive RF signals from a cable modem associated with the residence or business 114a.

In operation, the baseband processor 216 and/or the processor 204 may be operable to configure the switching element such as crossbar switch 306 to couple any one of the cable modem termination system ports 308-1, 308-2, . . . , 308-n to any channel corresponding one of the burst receivers/demodulators 304-1, 304-2, . . . , 304-m, which is selected to handle processing of signals received from any one of the customer premise cable modems. In this manner, any one of the cable modem termination system ports 308-1, 308-2, . . . , 308-n is operable to handle traffic from any channel for one of the residences and/or businesses 114a, 114b, 114c, . . . , 114n. A burst receiver/demodulator that is coupled to a particular cable modem termination system port may be operable to demodulate the signals received by that cable modem termination system port. The baseband processor 216 (FIG. 2) may be operable to process baseband signals resulting from demodulation by the burst receiver/demodulator that is coupled to the cable modem termination system port. The baseband signals resulting from demodulation by the burst receiver/demodulator may be stored in the memory 206 (FIG. 2).

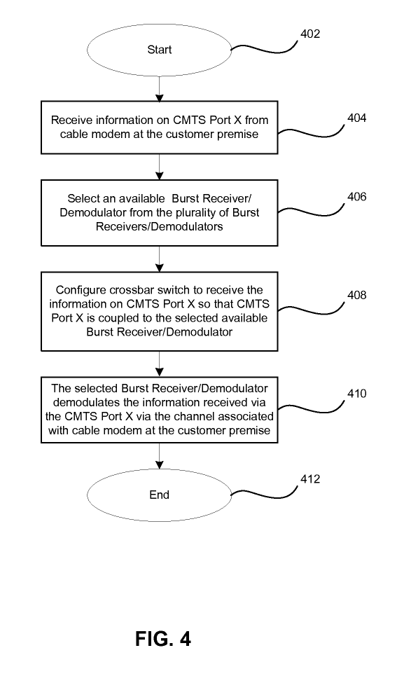

FIG. 4 is a flow chart illustrating exemplary steps for port switching for a plurality of burst receivers in a cable modem system in the cable headend, in accordance with an embodiment of the invention. The exemplary steps start at step 402. In step 404, information may be received on, for example, a cable modem termination system Port X from a cable modem at a customer premises. In step 406, an available Burst Receiver/Demodulator may be selected from the plurality of Burst Receivers/Demodulators. In step 408, the crossbar switch may be configured to receive the information on cable modem termination system Port X so that the cable modem termination system Port X is coupled to the selected available Burst Receiver/Demodulator. In step 410, the selected Burst Receiver/Demodulator demodulates the information that is received via the cable modem termination system Port X via the channel associated with the cable modem at a customer premises.

In accordance with various embodiments of the invention, a cable modem termination system device may comprise a plurality of cable modem termination system demodulators 304-1, 304-2, . . . , 304-M, a switching element such as a crossbar switch 306 and a plurality of cable modem termination system ports 308-1, 308-2, . . . , 308-N. The cable modem termination system device 302 may be operable to receive signals from one of a plurality of downstream cable modems at one of the plurality of cable modem termination system ports 308-1, 308-2, . . . , 308-N and dynamically assign one of the plurality of cable modem termination system demodulators 304-1, 304-2, . . . , 304-M to one of the plurality of cable modem termination system ports 308-1, 308-2, . . . , 308-N. The signals received from the one of the plurality of downstream cable modems may be demodulated by the assigned one of the plurality of cable modem termination system demodulators 304-1, 304-2, . . . , 304-M. The assigned one of the plurality of cable modem termination system demodulators 304-1, 304-2, . . . , 304-M may be communicatively coupled to one of the plurality of cable modem termination system ports 308-1, 308-2, . . . , 308-N by the switching element 306. In accordance with an embodiment of the invention, the switching element 306 may be operable to dynamically couple any one of the plurality of cable modem termination system demodulators 304-1, 304-2, . . . , 304-M to anyone of the plurality of cable modem termination system ports 308-1, 308-2, . . . , 308-N.

In various aspects of the invention, the plurality of cable modem termination system demodulators 304-1, 304-2, . . . , 304-M may be maintained as a pool of demodulating resources. Each of the plurality of cable modem termination system demodulators 304-1, 304-2, . . . , 304-M in the pool may be assigned a status. In this regard, a status of one or more of the plurality of cable modem termination system demodulators 304-1, 304-2, . . . , 304-M within the pool of demodulating resources may be marked as being available when the one or more cable modem termination system demodulators is available to handle demodulation of signals received at the one or more of the plurality of cable modem termination system ports 308-1, 308-2, . . . , 308-N. The status of the one or more of the plurality of cable modem termination system demodulators 304-1, 304-2, . . . , 304-M within the pool of demodulating resources may be marked as being unavailable when the one or more cable modem termination system demodulators is unavailable to handle demodulation of signals received at the one or more of the plurality of cable modem termination system ports. The status of the one of the plurality of cable modem termination system demodulators 304-1, 304-2, . . . , 304-M may be determined prior to being assigned to handle a cable modem termination system port. The one of the plurality of cable modem termination system demodulators 304-1, 304-2, . . . , 304-M may be assigned to the one of the plurality of cable modem termination system ports 308-1, 308-2, . . . , 308-N when the determined status of the one of the plurality of cable modem termination system ports 308-1, 308-2, . . . , 308-N is available. Another of the plurality of cable modem termination system demodulators 304-1, 304-2, . . . , 304-M may be assigned to the one of the plurality of cable modem termination system ports 308-1, 308-2, . . . , 308-N whenever the determined status of the one of the plurality of cable modem termination system ports 308-1, 308-2, . . . , 308-N is unavailable. Two or more of the plurality of cable modem termination system demodulators 304-1, 304-2, . . . , 304-M may be dynamically assigned to handle signals received from two or more of the plurality of cable modem termination system ports 308-1, 308-2, . . . , 308-N based on a class of service, latency and/or quality of service associated with the received signals. The switching element 306 may comprise a crossbar switch.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

Throughout this disclosure, the use of the terms dynamically and/or adaptively with respect to an operation means that, for example, parameters for, configurations for and/or execution of the operation may be configured or reconfigured during run-time (e.g., in, or near, real-time) based on newly received or updated information or data. For example, an operation within a transmitter and/or a receiver may be configured or reconfigured based on, for example, current, recently received and/or updated signals, information and/or data.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for dynamic cable modem termination system port to demodulator assignment in a cable headend.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method, comprising:
in a cable modem device comprising a plurality of cable modem termination system demodulators, a switching element and a plurality of cable modem termination system ports:
receiving signals from one of a plurality of downstream cable modems at one of said plurality of cable modem ports;
assigning one of said plurality of cable modem termination system demodulators to said one of said plurality of cable modem termination system ports; and
demodulating said signals received from said one of said plurality of downstream cable modems by said assigned one of said plurality of cable modem termination system demodulators.

2. The method according to claim 1, comprising communicatively coupling said assigned one of said plurality of cable modem termination system demodulators to said one of said plurality of cable modem termination system ports by said switching element.

3. The method according to claim 1, wherein said switching element is operable to dynamically couple any one of said plurality of cable modem termination system demodulators to anyone of said plurality of cable modem termination system ports.

4. The method according to claim 1, comprising maintaining said plurality of cable modem termination system demodulators as a pool of demodulating resources.

5. The method according to claim 4, comprising:
marking a status of one or more cable modem termination system demodulators within said pool of demodulating resources as being available when said one or more cable modem termination system demodulators is available to handle demodulation of signals from one or more of said plurality of cable modem termination system ports; and
marking said status of said one or more cable modem termination system demodulators within said pool of demodulating resources as being unavailable when said one or more cable modem termination system demodulators is unavailable to handle demodulation of signals from said one or more of said plurality of cable modem termination system ports.

6. The method according to claim 5, comprising determining said status of said one of said plurality of cable modem termination system demodulators prior to said assigning.

7. The method according to claim 6, comprising assigning said one of said plurality of cable modem termination system demodulators to said one of said plurality of cable modem termination system ports when said determined status of said one of said plurality of cable modem termination system ports is available.

8. The method according to claim 6, comprising assigning another of said plurality of cable modem termination system demodulators to said one of said plurality of cable modem termination system ports when said determined status of said one of said plurality of cable modem termination system ports is unavailable.

9. The method according to claim 1, comprising dynamically assigning two or more of said plurality of cable modem termination system demodulators to handle signals received from two or more of said plurality of cable modem termination system ports based on a class of service, latency and/or quality of service associated with said received signals.

10. The method according to claim 1, wherein said switching element comprises a crossbar switch.

11. A system, comprising:
a cable modem termination system device comprising a plurality of cable modem termination system demodulators, a switching element and a plurality of cable modem termination system ports, said cable modem device being operable to:
receive signals from one of a plurality of downstream cable modems at one of said plurality of cable modem termination system ports;
assign one of said plurality of cable modem termination system demodulators to said one of said plurality of cable modem termination system ports; and
demodulate said signals received from said one of said plurality of downstream cable modems by said assigned one of said plurality of cable modem termination system demodulators.

12. The system according to claim 11, wherein said switching element is operable to communicatively couple said assigned one of said plurality of cable modem termination system demodulators to said one of said plurality of cable modem ports by said switching element.

13. The system according to claim 11, wherein said switching element is operable to dynamically couple any one of said plurality of cable modem termination system demodulators to anyone of said plurality of cable modem termination system ports.

14. The system according to claim 11, comprising maintaining said plurality of cable modem termination system demodulators as a pool of demodulating resources.

15. The system according to claim 14, wherein said cable modem termination system device is operable to:
mark a status of one or more cable modem termination system demodulators within said pool of demodulating resources as being available when said one or more cable modem termination system demodulators is available to handle demodulation of signals from one or more of said plurality of cable modem termination system ports; and
mark said status of said one or more cable modem termination system demodulators within said pool of demodulating resources as being unavailable when said one or more cable modem termination system demodulators is unavailable to handle demodulation of signals from said one or more of said plurality of cable modem termination system ports.

16. The system according to claim 15, wherein said cable modem termination system device is operable to determine said status of said one of said plurality of cable modem termination system demodulators prior to said assigning.

17. The system according to claim 16, wherein said switching element is operable to assign said one of said plurality of cable modem termination system demodulators to said one of said plurality of cable modem ports when said determined status of said one of said plurality of cable modem termination system ports is available.

18. The system according to claim 16, wherein said switching element is operable to assign another of said plurality of cable modem termination system demodulators to said one of said plurality of cable modem termination system ports when said determined status of said one of said plurality of cable modem termination system ports is unavailable.

19. The system according to claim 11, wherein said switching element is operable to dynamically assign two or more of said plurality of cable modem termination system demodulators to handle signals received from two or more of said plurality of cable modem termination system ports based on a class of service, latency and/or quality of service associated with said received signals.

20. The system according to claim 11, wherein said switching element comprises a crossbar switch.
